(19) United States
(12) Patent Application Publication
(10) Pub. No.: US 2007/0073854 A1
(43) Pub. Date: Mar. 29, 2007

(54) Communication terminals having multiple processors and methods of operating the same

(76) Inventor: Tobias Lindquist, Sundbyberg (SE)

Correspondence Address: MYERS BIGEL SIBLEY & SAJOVEC, P.A., P.O. BOX 37428, RALEIGH, NC, 27627, US

(21) Appl. No.: 11/229,975

(22) Filed: Sep. 19, 2005

(51) Int. Cl. G06F 15/173

(52) U.S. Cl. 709/223

(57) ABSTRACT

A wireless communication terminal includes an application controller configured to execute a plurality of application programs and to provide access to one or more local services executed therein, a communication controller configured to provide a plurality of communication services, and a bridge component coupled between the application controller and the communication controller and configured to receive a service access request from an application executed by the application controller and to selectively route the service access request to one of the local services of the application controller or one of the communication services of the communication controller.

### FIELD OF THE INVENTION

The present invention generally relates to wireless communication terminals, and more particularly to wireless communication terminals having processors and methods for operating wireless communication terminals having processors.

### BACKGROUND

Wireless communication terminals such as mobile telephones include increasingly more functionality. For example, wireless communication terminals may include a digital still and/or video camera, one or more display screens (including display screens capable of displaying video signals), microphones, speakers, and other audiovisual input/output devices. In addition, some wireless communication terminals include advanced application software such as web browsers, personal organizers, video games, e-mail clients, and other software applications.

At the same time, wireless communication terminals have evolved from cellular telephones that supported a single communication medium using a single interface to multi-function communication devices that support a wide range of communication services, from standard analog and/or digital wireless telephony services to Bluetooth personal networking, wireless local area network (WLAN) connectivity, paging, GPS, satellite, and other types of communication services.

Some wireless communication terminals, in particular those wireless terminals that include an integrated display, speaker and/or camera, are capable of generating, acquiring, storing, processing, displaying and/or playing various kinds of digital data signals. Such digital data signals may include, for example, audio signals such as voice, music or other audio signals, still image signals, and/or video data signals (which may or may not include accompanying digital audio signals). Processing such digital signals in real time or near-real time may require a large amount of bandwidth and/or computer processing power.

As more and more applications demand network connectivity, and as wireless communication terminals are asked to perform more and more end-user applications, often simultaneously, the performance and operational demands placed on the microprocessor of a wireless communication terminal are increased correspondingly. For example, some communication services, such as voice and/or video telephony, may preferably utilize real-time or near real-time processing of signals received over an air interface in order to be able to play the received signal with minimal interruptions. With many application programs competing for processing resources along with myriad communication services, it may be difficult to provide such processing capability. In addition, while some applications may be relatively insensitive to response time, it may be desirable to provide a relatively fast response time for certain applications such as, for example, applications which utilize a user interface.

Programming wireless communication devices may become complicated by the large number of potential services available to each application, particularly wireless communication services. It may be difficult to modify and/or upgrade the software used to operate a particular service without modifying and/or upgrading the code of the applications using such service. For example, each of the above-referenced functions (video display, camera, WLAN, Bluetooth, GPS) may require an associated software driver with an application programming interface (API) and/or other software “hooks” which may be known to the application desiring to make use of such functions.

Distributed object brokers, such as those described in the CORBA specification, may be used to provide transparent access to distributed services. However, such schemes may not be appropriate for wireless terminal architectures. In particular, such schemes may require extensive integration work and may introduce undesired latency into the system.

### SUMMARY

A wireless communication terminal according to some embodiments of the invention includes an application controller configured to execute a plurality of application programs and to provide access to one or more local services executed therein, a communication controller configured to provide a plurality of communication services, and a bridge component coupled between the application controller and the communication controller and configured to receive a service access request from an application executed by the application controller and to selectively route the service access request to one of the local services of the application controller or one of the communication services of the communication controller.

The bridge component may include a first router component in the application controller and a second router component in the communication controller, and the first router component may be configured to receive a service access request from an application in the application controller and determine if the service access request may be intended for one of the local services of the application controller or one of the communication services of the communication controller.

The first router component may be further configured to route a service access request destined for one of the local services to the one of the local services and to route a service request destined for one of the communication services to the second router component in the communication controller.

The second router component may be configured to receive a service access request from the first router component or from an application program in the communication controller and to selectively route the service access request to one of the communication services of the communication controller or to the first router component based on a service specified in the service access request.

The second router component may be further configured to receive data from a communication service and to selectively route the received data to the first router component or to an application program in the communication controller based on an intended destination of the received data.

The first router component may be further configured to receive data from a local service or from the second router component and to selectively forward the data to an application program located in the application controller or to the second router component based on an intended destination of the received data.

The communication controller may further include one or more remote application programs, and the second router component may be configured to receive a service access request from a remote application in the communication controller and determine if the service access request is intended for a service operated by the communication controller or a service operated by the application controller. The second router component may route service access requests intended for a service operated by the application controller to the first router component. The first router component may be further configured to receive a service access request from the second router component and to route the service access request received from the second router component to a local service.

The second router component may be further configured to place a received service access request intended for a communication service operated by the communication controller in a queue based on a priority of the received service access request. The second router component may be further configured to send a queued service access request to a communication service responsive to receiving an indication from the communication controller that the communication service is ready to process the queued service access request.

A wireless communication terminal according to some embodiments of the invention includes a first processor configured to execute a plurality of application programs and to provide access to one or more services operated by the first processor, a second processor configured to execute a plurality of application programs and to provide access to one or more services operated by the second processor, and a bridge component coupled between the first processor and the second processor and configured to receive a service access request from an application in the first processor or from an application in the second processor and to selectively route the service access request to a service operated by the first processor or a to a service operated by the second processor based on a service specified in the service access request.

The bridge component may include a first router component in the first processor and a second router component in the second processor, and the first router component may be configured to receive a service access request from an application in the first processor and determine if the service access request is intended for a service operated by the first processor or a service operated by the second processor.

The first router component may be further configured to route a service access request intended for a service operated by the first processor to the intended service and to route a service request intended for a service operated by the second processor to the second router component in the second processor.

The second router component may be configured to receive a service access request from the first router component and route the service access request to a service operated by the second processor.

The second router component may be further configured to receive data from a service operated by the second processor and to route the received data to the first router component.

The first router component may be further configured to receive data from a service operated by the first processor or from the second router component and forward the data to an application program in the first processor.

The second processor may further include one or more application programs. The second router component may be configured to receive a service access request from an application in the second processor and determine if the service access request is intended for a service operated by the second processor or a service operated by the first processor and to route a service access request intended for a service operated by the first processor to the first router component. The first router component may be further configured to receive a service access request from the second router and to route the service access request received from the second router to a service operated by the first processor.

The second router component may be further configured to place a received service access request intended for a service operated by the second processor in a queue based on a priority of the received service access request.

The second router component may be further configured to send a queued service access request to a selected service responsive to receiving an indication from the second processor that the service is ready to process the queued service access request.

Methods of providing offload communication processing in a wireless communication terminal according to some embodiments of the invention include providing an application processor in the wireless communication terminal, providing a communication processor in the wireless communication terminal, providing a bridge component coupled to the application processor and the communication processor, transmitting a service access request from an application in the application controller to the bridge component, and selectively routing the service access request to a local service operated by the application controller or to a communication service operated by the communication controller based on a service specified in the service access request.

Transmitting a service access request from an application in the application controller to the bridge component may include transmitting a service access request from an application in the application controller to a first router component in the application processor.

Routing the service access request to a communication service operated by the communication controller may include forwarding the service access request to a second router component in the communication controller.

Some methods according to embodiments of the invention further include receiving at the second router component a forwarded service access request from the first router component, and routing the forwarded service access request to a communication service operated by the communication controller.

Some methods according to embodiments of the invention further include enqueueing the service access request according to a priority of the service access request. Thus, routing the forwarded service access request to a communication service operated by the communication controller may include routing a queued service access request.

Some methods further include receiving data at the first router component from a local service or from the second router component and forwarding the received data to an application program in the application controller.

Some methods according to embodiments of the invention further include receiving at the second router a service access request from a remote application in the communication controller, determining if the service access request is intended for a service operated by the communication controller or a service operated by the application controller, and selectively routing the service access request to a service operated by the communication controller or to the first router component based on an intended destination of the service access request.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic block diagram illustrating wireless communication terminals and communication systems in accordance with some embodiments of the invention.

FIG. 2 is a schematic block diagram of a conventional wireless communication terminal.

FIG. 3 is a schematic block diagram of a wireless communication terminal according to some embodiments of the invention.

FIG. 4 is a diagram of the Open Systems Interconnection reference model for data communication.

FIGS. 5-6 are schematic block diagrams of wireless communication terminals according to some embodiments of the invention.

FIGS. 7-8 are flow diagrams illustrating operations according to some embodiments of the invention.

### DETAILED DESCRIPTION OF EMBODIMENTS OF THE INVENTION

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout. As used herein the term “comprising” or “comprises” is open-ended, and includes one or more stated elements, steps and/or functions without precluding one or more unstated elements, steps and/or functions. As used herein the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

Embodiments according to the present invention are described with reference to block diagrams and/or operational illustrations of methods and communication terminals. It is to be understood that each block of the block diagrams and/or operational illustrations, and combinations of blocks in the block diagrams and/or operational illustrations, can be implemented by radio frequency, analog and/or digital hardware, and/or program instructions. These program instructions may be provided to a controller, which may include one or more general purpose processors, special purpose processors, ASICs, and/or other programmable data processing apparatus, such that the instructions, which execute via the controller and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer usable program code embodied in the medium. Any suitable computer readable medium may be utilized including hard disks, CD ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language, assembly language, or other programming languages.

As used herein, a “wireless communication terminal” includes, but is not limited to, a terminal that is configured to receive/transmit communication signals via a wireless interface with, for example, a cellular network, a wireless local area network (WLAN), and/or another communication terminal. Examples of wireless communication terminals include, but are not limited to, a cellular telephone, personal data assistant (PDA), pager, and/or a computer that is configured to communicate data over a wireless communication interface that can include a cellular telephone interface, a Bluetooth interface, a wireless local area network interface (e.g., 802.11), another RF communication interface, and/or an optical/infra-red communication interface.

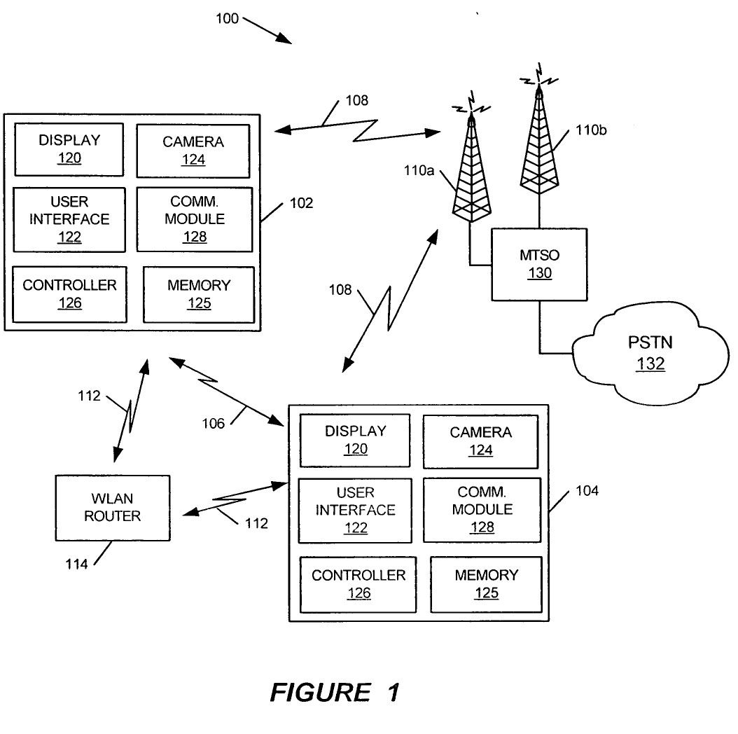

FIG. 1 is a schematic block diagram of a wireless communication system 100 that includes two wireless terminals 102, 104 that are configured to communicate data with one another over a direct wireless communication interface 106 therebetween, over another wireless communication interface 108 through one or more cellular base stations 110a-b, and/or over another wireless communication interface 112 through a wireless local area network (WLAN) router 114. The wireless terminals 102, 104 include a display device 120, a user interface 122, a camera device 124, a controller 126, a communication module 128, and a memory 125.

The camera device 124 is configured to generate a still image and/or video data stream based on incident light. The user interface 122 can include, for example, a keypad, keyboard, touchpad, jog dial and/or other user input device. The user interface 122 can also include a microphone coupled to an audio processor that is configured to generate an audio data stream responsive to sound incident on the microphone, and a speaker that generates sound responsive to an input audio signal. The communication module 128 is configured to communicate data over one or more of the wireless interfaces 106, 108, and/or 112 to another remote wireless terminal 102, 104. The memory 125 is configured to store a digital information signal such as a digital audio and/or video signal generated by the camera device 124 and/or the microphone of the user interface 122.

The communication module 128 can include a cellular communication module, a Bluetooth module, and/or a WLAN module. With a cellular communication module, the wireless terminals 102, 104 can communicate via the base stations 110a-b using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations 110a-b are connected to a Mobile Telephone Switching Office (MTSO) 130 wireless network, which, in turn, is connected to a PSTN 132 and/or another network. With a Bluetooth module, the wireless terminal 102, 104 can communicate via an ad-hoc network through the direct interface 106. With a WLAN module, the wireless terminal 102, 104 can communicate through the WLAN router 114 using a communication protocol that may include, but is not limited to, 802.11a, 802.11b, 802.11e, 802.11g, 802.11i.

The wireless terminals 102, 104 are configured to transmit and/or receive a digital data signal between one another and/or with another communication terminal that may be communicatively coupled thereto through, for example the MTSO 130 and the PSTN 132 and/or another network.

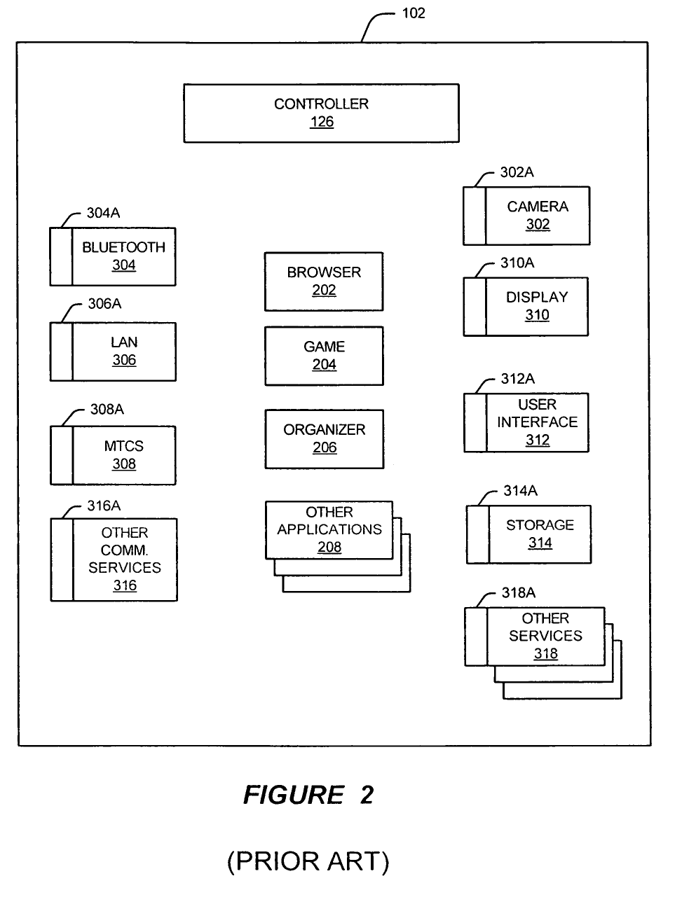

Referring to FIG. 2, the organization of application programs and services in a wireless terminal 102 is illustrated schematically. As shown therein, a wireless terminal 102 includes a controller 126 which executes a number of application programs and operates a number of services. Application programs executed by the controller 126 may include an internet/web browser 202, a game program 204, a calendar/organizer program 206 and/or other applications 208 such as, for example, email clients, graphics programs, and even word processing programs. Services operated by the controller may include, for example, a camera 302, a Bluetooth communication system 304, a wireless LAN 306, a mobile telephone communication service 308, such as GSM, GPRS, CDMA2000, etc., a graphic display 310, a user interface 312, a data storage system 314, other communication services 316, and/or other services 318.

As further illustrated in FIG. 2, each service includes an associated software driver which controls the functionality of the associated service. For example, the camera 302 includes an associated software driver 302A which may control the functionality of the camera. For example, the software driver 302A may provide orderly access to the camera services by various application programs, may format data generated by the camera for provision to application programs requesting the data, and/or may provide initialization, reset, troubleshooting and/or other services for the camera 302.

Similarly, the Bluetooth service 304 may include an associated software driver 304A which facilitates access to the Bluetooth ad-hoc networking service by software applications. The mobile telephone communication service 308 may include an associated software driver 308A, and so on.

As noted above, programming wireless communication devices such as wireless terminal 102 may become complicated by the large number of potential services, particularly wireless communication services, available to each application. It may be difficult to modify and/or upgrade the software used to operate a particular service without modifying and/or upgrading the code of the applications using such service. Moreover, each application and service running in the wireless terminal 102 competes for resources from the controller 126. As the number of applications and services in the wireless terminal 102 is increased, it may become increasingly difficult for the controller 126 to perform the requested functions.

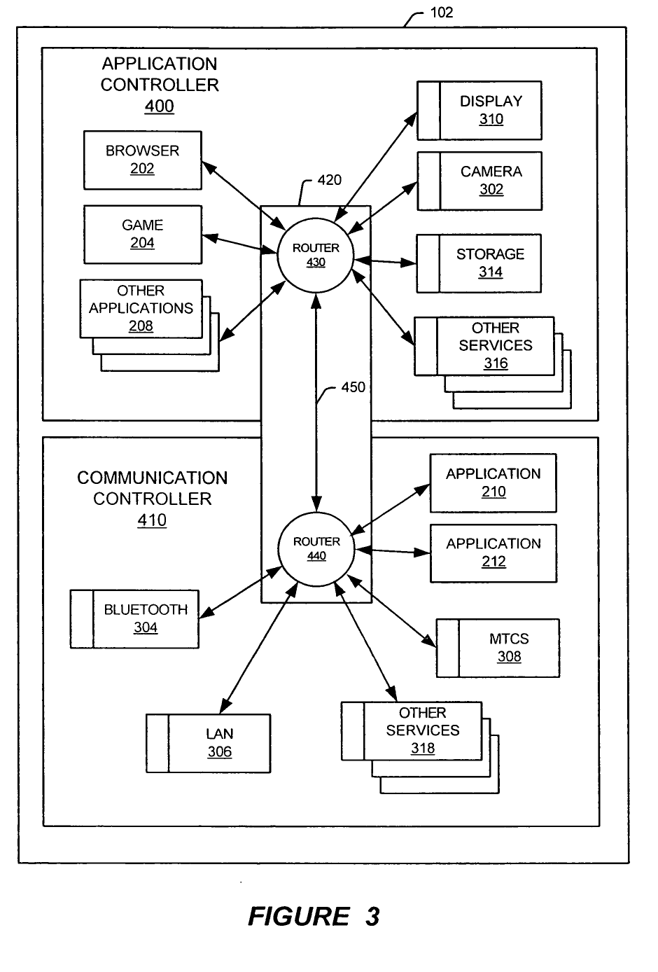

Accordingly, FIG. 3 illustrates a wireless terminal 102′ in accordance with some embodiments of the invention. As shown therein, a wireless terminal 102′ includes an application controller 400 that is configured to operate one or more application programs, such as an internet/web browser 202, a computer game 204 and/or other application programs 208. In addition to operating application programs, the application controller 400 may operate one or more local services, such as, for example, a camera 302, a display 310, a data storage 314 and/or other services 316.

Wireless terminal 102′ also includes a dedicated communication controller 410 that is configured to operate a plurality of communication services including, for example, a Bluetooth communication service 304, a wireless LAN communication service 306, a mobile telephone communication service 308, and/or other communication services. The communication controller 410 may operate other services besides communication services. For example, the communication controller 410 may additionally operate a storage service, a GPS service or other service.

In addition, the communication controller 410 may operate one or more application programs such as application 210 and/or application 212 in addition to operating one or more communication services.

In order to permit application programs in the application controller 400 to access services operated by the application controller 400 and/or the communication controller 410, application controller 400 includes a first router component 430 which is configured to receive service access requests from the application programs and/or from the operating system of the application controller 400, and forward such requests to the appropriate service. Thus, instead of accessing services directly, an application program may provide a service access request to the first router component 430, which forwards the service access request to the designated service, either directly or via a second router component.

It will be appreciated that in some cases, it may be desirable to bypass operation of the first router component 430 and permit local applications (i.e. applications running in the application controller 400) to access a local service (i.e. a service operated by the application controller 400) directly. For example, it may be desirable to allow an application which processes a large amount of data to have direct access to a service such as the storage service 314 to permit the application to perform a direct read/write from/to such service.

Similarly, communication controller 410 may include a second router component 440 which is configured to receive service access requests from applications within the communication controller 410 and forward such requests to the designated service.

As further illustrated in FIG. 3, the first router component 430 in the application controller 400 and the second router component 440 in the communication controller 410 are connected by a bridge 420 which permits the first router component 430 to forward service access requests for services operated by the communication controller 410 to the appropriate service, and vice-versa. In particular, the bridge 420 may include a bi-directional communication link 450 between the first router component 430 and the second router component 440. The bi-directional communication link 450 may include a serial communication pathway such as, for example, a high-speed universal serial bus (USB) link or an IEEE 1394 FireWire link. Alternatively, the communication link 450 may include a parallel data communication pathway. The data communication link 450 may be configured for half-duplex and/or full-duplex operation. In some embodiments, the data communication link may provide separate data communication pathways for sending/receiving service access requests from an application program to/from a service and for sending/receiving data such as user data between an application program and a service.

In some embodiments of the invention, the operation of the bridge 420 including the first router component 430 and the second router component 440 may permit application programs to have transparent, organized access to the various services provided within the wireless communication terminal 102′ without reference to or even explicit knowledge of which controller is actually operating the service. Moreover, because applications may not access services directly, the services and associated driver software may be replaced without affecting existing application program code.

For example, the first router component 430 is configured to receive a service access request from an application in the application controller 400 and determine if the service access request is intended for a local service (i.e. a service operated by the application controller 400) or a remote service (i.e. a service operated by the communication controller 410). The first router component 430 routes a service access request destined for a local service to the local service, and routes a service request destined for a remote service to the second router component 440 in the communication controller 410 via the bi-directional data link 450.

The second router component 440 is configured to receive a service access request from the first router component 430 or from an application program in the communication controller 410 and route the service access request to a communication service operated by the communication controller 410 or to the first router component 430 based on the service specified in the service access request.

The second router component 440 is further configured to receive data from a communication service and to route the received data to the first router component 430 or to an application program in the communication controller 410 based on an intended destination of the received data.

The first router component 430 is further configured to receive data from a local service and/or from the second router component 440 and forward the data to an application program located in the application controller 400 or to the second router component 440 based on an intended destination of the received data.

The first router component 430 may additionally be configured to receive a service access request from the second router component 440 and to route the service access request received from the second router component 440 to a local service operated by the application controller 400.

In some cases, a service access request may be received by a router component while the specified service is busy. In that case, the router component may queue the service access request until the requested service is available. For example, a second router component 440 may be configured to place a received service access request intended for a communication service operated by the communication controller 410 in a queue based on a priority of the received service access request. The second router component 440 may be further configured to send a queued service access request to a communication service responsive to receiving an indication from the communication controller 410 that the communication service is ready to process the queued service access request. The first router component 430 may be similarly configured with respect to service access requests specifying a service operated by the application controller 400.

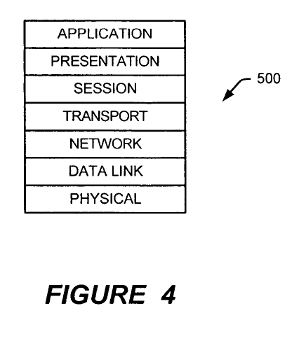

Embodiments of the invention may be understood with reference to the Open Systems Interconnection reference model for data communication 460 (the “OSI model”) shown in FIG. 4. While the OSI model is an idealized framework, it provides a useful model for understanding the organization of a data communication system. In particular, the OSI model is a reference framework for data communication in a networking environment designed to facilitate interoperability among different computer systems. The OSI model organizes the functions of a communication system protocol into a series of layers, each of which corresponds to a protocol or set of protocols in the communication link. In addition, each layer in a terminal communicates with a corresponding layer in the remote terminal. Each layer uses the functions of the layer below, and provides functionality to the layer above.

As illustrated in FIG. 4, the seven layers of the OSI model include, from top down, the Application, Presentation, Session, Transport, Network, Data Link and Physical layers. Thus, for example, an application in local terminal (at the application layer) may communicate with an application in a remote terminal by passing data to the presentation layer in the local terminal which processes the data according to the protocols of the presentation layer and passes the data down to the Session layer. The process continues until the formatted data is ultimately transmitted over the physical network to the remote terminal. The physical network may include a data bus, a serial link, a wireless RF link, an optical link, an infrared link, an Ethernet connection or any other physical network connection. The function of each of the layers is indicated in Table 1, below.

TABLE 1
OSI Reference Model Layers

| Layer | Function |
|---|---|
| Layer 7 - Application | End-user application services |
| Layer 6 - Presentation | Data formatting and coding |
| Layer 5 - Session | Dialog management |
| Layer 4 - Transport | End to end communication |
| | management, including error recovery |
| | and flow control |
| Layer 3 - Network | Routing and addressing |
| Layer 2 - Data Link | Protocols for operating communication |
| | lines, including error detection and |
| | correction |
| Layer 1 - Physical | Physical control of data communication |
| | circuits and media |

As will be apparent from the foregoing discussion, a particular terminal need not implement all seven layers. For example, an intermediate terminal in a communication system may implement only a subset of the layers. Moreover, depending on the configuration of the system, implementation of some of the layers may be highly simplified and/or bypassed altogether.

A system that implements protocol behavior consisting of a series of these layers is known as a ‘protocol stack’ or ‘stack’. Protocol stacks can be implemented either in hardware or software, or a mixture of both. Typically, only the lower layers are implemented in hardware, with the higher layers being implemented in software. In many implementations, various layers may be combined together.

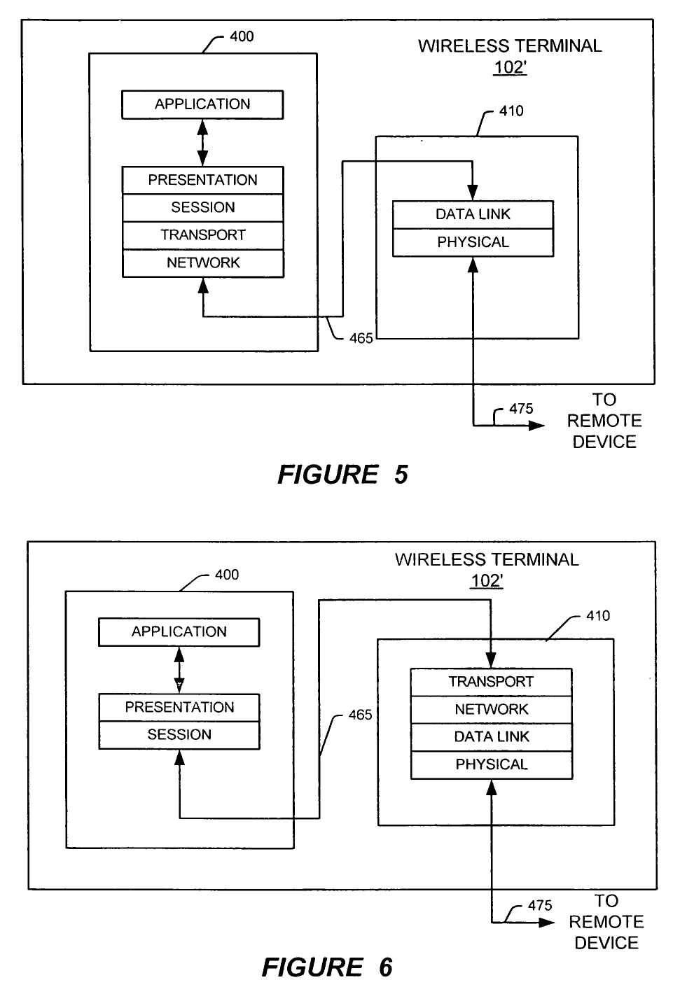

An exemplary configuration of a wireless terminal 102′ is illustrated in FIG. 5. As shown therein, responsibility for managing various layers in a communication protocol may be divided between the application controller 400 and the communication controller 410. For example, management of the data link and physical layers of the communication protocol may be performed by communication controller 410, thereby relieving the application controller 400 of the burden of managing the data link and physical layers of communication. This arrangement may be particularly beneficial for wireless terminals which support a large number of communication pathways and media, for example, wireless, wired, and/or infrared communications. In the embodiment illustrated in FIG. 5, a large part of the communication stack is implemented in the application controller 400. For example, the application controller 400 may operate a TCP/IP stack which communicates over an internet connection while the communication controller 410 is dedicated to controlling the physical communication links. In this case, since the duties of the communication controller 410 are limited, the communication controller may be able to manage multiple data links more efficiently and with fewer interruptions.

Data processed through the network layer by the application controller 400 may be passed to the communication controller 410 by means of link 465, which may correspond to the bidirectional data link 450 illustrated in FIG. 3. Thus, while the application controller 400 still communicates with the communication controller 410 over a physical link, the communication pathway between the application controller 400 and the communication controller 410 may be highly simplified. Data is transmitted by the communication controller 410 via link 475 which, as explained above, may be an RF, wired, infrared, optical or other link.

Another possible configuration is illustrated in FIG. 6, in which a wireless terminal 102′ includes a communication controller 410 that is configured to implement higher layers of the OSI model. For example, the communication controller 410 may implement the transport and network layers in addition to operating the data link and physical layers of the communication pathway, thereby further offloading processing duties from the application controller 400 and allowing the application controller 400 to operate multiple application programs more efficiently and effectively. In either case, applications may access communication services without explicit knowledge of specific communication protocols or where the services are located.

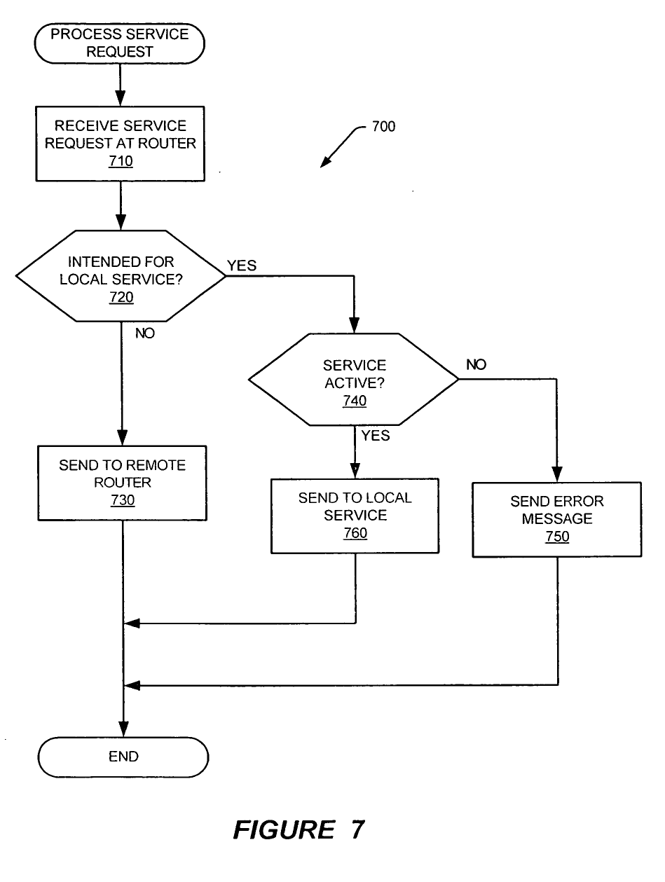

Methods according to some embodiments of the invention are illustrated in FIG. 7, which shows methods 700 for processing service requests by a router component 430, 440. In particular, when a service request is received at a router component (block 710), a check is made (block 720) to see if the request is directed to a local service (i.e. a service operated by the controller in which the router component is located) or a remote service (i.e. a service operated by another controller in the wireless terminal). The service request may be received from a local application or it may be received via the bridge connection from another router component in the wireless terminal. If the request is not destined for a local service, the router component forwards the request to the remote router (block 730). If the request is destined for a local service, a check is made to see if the local service is active (block 740). If the service is active, the service request is forwarded to the active local service (block 760). If the service is inactive, an error message is returned to the requestor (block 750).

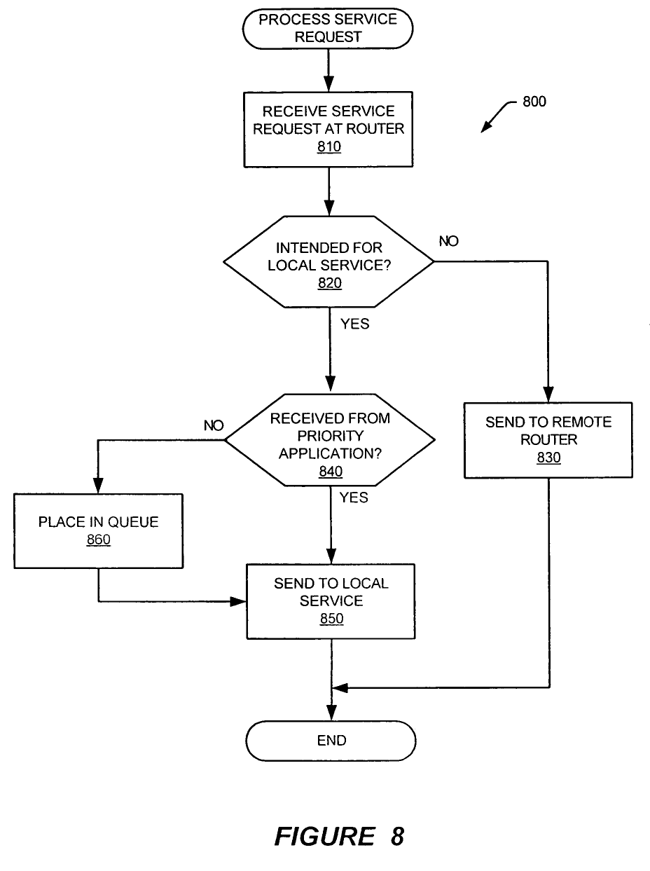

Further methods according to embodiments of the invention are illustrated in FIG. 8. In particular, FIG. 8 illustrates additional methods 800 for processing service requests received at a router component. Multiple applications may request access to a particular service operated by the application controller 400 and/or the communication controller 410. Moreover, an application may have no awareness of requests made by other applications for service access from the same service. Thus, it is possible that a service access request could be made by one application while the service is already busy processing a service request made by a different application. In that case, the later-received service access request may be queued until the requested service is free to process the request.

In some embodiments, applications may be assigned a priority based on the importance of the application. A service request from an application may be placed in a service request queue based on the priority of the application that issued the request. Thus, a later-received service request may be placed higher in a service request queue than an earlier-received service request if the priority of the application making the later-received service request is higher than the priority of the application making the earlier-received service request. In some cases, applications may be designated as “priority applications” for which requests are not enqueued at all, but are sent immediately to the requested service. For example, applications that require real-time or near real time processing of service requests may be designated as “priority applications.”

When a service request is received at a router component (block 810), a check is made to see if the request is intended for a local service (block 820). If not, the request is forwarded to a remote router (block 830). If the request is destined for a local service, a check is made to see if the request is made from a priority application (block 840). If the request is from a priority application, the request may be forwarded directly to the local service (block 850). If the request is not from a priority application, then the request is placed in a service request queue for the requested service (block 860). In some embodiments, the request is placed in the service request queue according to the priority of the application making the request. The queued request is processed when the requested service is available (i.e. when the service is free and all higher-priority and/or earlier-received requests have been processed).

Wireless terminals according to some embodiments of the invention have been described as including an application processor including a router component and a communication processor including a router component, wherein the router components are connected by a bidirectional data link. It will be apparent that the present invention may be embodied in a terminal including more than two controllers and/or more than two router components. For example a wireless terminal according to embodiments of the invention could include an interface controller for controlling a user interface in addition to an application controller 400 and a communication controller 410. The interface controller could include a router component forming part of a bridge with router components of the application controller 400 and the communication controller 410.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A wireless communication terminal comprising:
an application controller that is configured to execute a plurality of application programs and to provide access to one or more local services executed therein;
a communication controller that is configured to provide a plurality of communication services; and
a bridge component that is coupled between the application controller and the communication controller and that is configured to receive a service access request from an application executed by the application controller and to selectively route the service access request to one of the local services of the application controller or one of the communication services of the communication controller.

2. The wireless communication terminal of claim 1, wherein the bridge component comprises a first router component in the application controller and a second router component in the communication controller, and wherein the first router component is configured to receive a service access request from an application in the application controller and determine if the service access request is intended for one of the local services of the application controller or one of the communication services of the communication controller.

3. The wireless communication terminal of claim 2, wherein the first router component is further configured to route a service access request destined for one of the local services to the one of the local services and to route a service request destined for one of the communication services to the second router component in the communication controller.

4. The wireless communication terminal of claim 2, wherein the second router component is configured to receive a service access request from the first router component or from an application program in the communication controller and to selectively route the service access request to one of the communication services of the communication controller or to the first router component based on a service specified in the service access request.

5. The wireless communication terminal of claim 4, wherein the second router component is further configured to receive data from a communication service and to selectively route the received data to the first router component or to an application program in the communication controller based on an intended destination of the received data.

6. The wireless communication terminal of claim 5, wherein the first router component is further configured to receive data from a local service or from the second router component and to selectively forward the data to an application program located in the application controller or to the second router component based on an intended destination of the received data.

7. The wireless communication terminal of claim 2, wherein the communication controller further comprises one or more remote application programs, the second router component is configured to receive a service access request from a remote application in the communication controller and determine if the service access request is intended for a service operated by the communication controller or a service operated by the application controller and to route service access requests intended for a service operated by the application controller to the first router component, and the first router component is further configured to receive a service access request from the second router component and to route the service access request received from the second router component to a local service.

8. The wireless communication terminal of claim 2, wherein the second router component is further configured to place a received service access request intended for a communication service operated by the communication controller in a queue based on a priority of the received service access request.

9. The wireless communication terminal of claim 8, wherein the second router component is further configured to send a queued service access request to a communication service responsive to receiving an indication from the communication controller that the communication service is ready to process the queued service access request.

10. A wireless communication terminal comprising:
a first processor that is configured to execute a plurality of application programs and to provide access to one or more services operated by the first processor;
a second processor that is configured to execute a plurality of application programs and to provide access to one or more services operated by the second processor; and
a bridge component that is coupled between the first processor and the second processor and that is configured to receive a service access request from an application in the first processor or from an application in the second processor and to selectively route the service access request to a service operated by the first processor or a to a service operated by the second processor based on a service specified in the service access request.

11. The wireless communication terminal of claim 10, wherein the bridge component comprises a first router component in the first processor and a second router component in the second processor, and wherein the first router component is configured to receive a service access request from an application in the first processor and determine if the service access request is intended for a service operated by the first processor or a service operated by the second processor.

12. The wireless communication terminal of claim 11, wherein the first router component is further configured to route a service access request intended for a service operated by the first processor to the intended service and to route a service request intended for a service operated by the second processor to the second router component in the second processor.

13. The wireless communication terminal of claim 11, wherein the second router component is configured to receive a service access request from the first router component and route the service access request to a service operated by the second processor.

14. The wireless communication terminal of claim 13, wherein the second router component is further configured to receive data from a service operated by the second processor and to route the received data to the first router component.

15. The wireless communication terminal of claim 14, wherein the first router component is further configured to receive data from a service operated by the first processor or from the second router component and forward the data to an application program in the first processor.

16. The wireless communication terminal of claim 11, wherein the second processor further comprises one or more application programs, the second router component is configured to receive a service access request from an application in the second processor and determine if the service access request is intended for a service operated by the second processor or a service operated by the first processor and to route a service access request intended for a service operated by the first processor to the first router component, and the first router component is further configured to receive a service access request from the second router and to route the service access request received from the second router to a service operated by the first processor.

17. The wireless communication terminal of claim 11, wherein the second router component is further configured to place a received service access request intended for a service operated by the second processor in a queue based on a priority of the received service access request.

18. The wireless communication terminal of claim 17, wherein the second router component is further configured to send a queued service access request to a selected service operated by the second processor responsive to receiving an indication from the second processor that the selected service is ready to process the queued service access request.

19. A method of providing offload communication processing in a wireless communication terminal, comprising:
providing an application processor in the wireless communication terminal;
providing a communication processor in the wireless communication terminal;
providing a bridge component coupled to the application processor and the communication processor;
transmitting a service access request from an application in the application controller to the bridge component; and
selectively routing the service access request to a local service operated by the application controller or to a communication service operated by the communication controller based on a service specified in the service access request.

20. The method of claim 19, wherein transmitting a service access request from an application in the application controller to the bridge component comprises transmitting a service access request from an application in the application controller to a first router component in the application processor.

21. The method of claim 19, wherein routing the service access request to a communication service operated by the communication controller comprises forwarding the service access request to a second router component in the communication controller.

22. The method of claim 21, further comprising:
receiving at the second router component a forwarded service access request from the first router component; and
routing the forwarded service access request to a communication service operated by the communication controller.

23. The method of claim 22, further comprising enqueueing the service access request according to a priority of the service access request, wherein routing the forwarded service access request to a communication service operated by the communication controller comprises routing a queued service access request.

24. The method of claim 22, further comprising receiving data at the first router component from a local service or from the second router component and forwarding the received data to an application program in the application controller.

25. The method of claim 24, wherein the communication controller further comprises one or more remote application programs, the method further comprising:
receiving at the second router a service access request from a remote application in the communication controller;
determining if the service access request is intended for a service operated by the communication controller or a service operated by the application controller; and
selectively routing the service access request to a service operated by the communication controller or to the first router component based on an intended destination of the service access request.
